(19) United States
(12) Patent Application Publication
(10) Pub. No.: US 2006/0199614 A1
(43) Pub. Date: Sep. 7, 2006

(54) Universal cellular circuit board

(76) Inventor: Berg P. Hyacinthe, Tallahassee, FL (US)

Correspondence Address: DENNIS L. COOK, ESQ.;THE LAW OFFICES OF DENNIS L COOK PLLC, 12718 DUPONT CIRCLE, TAMPA, FL, 33626, US

(21) Appl. No.: 11/271,715

(22) Filed: Nov. 12, 2005

Related U.S. Application Data
(60) Provisional application No. 60/658,035, filed on Mar. 2, 2005.

(51) Int. Cl. H04B 1/38

(52) U.S. Cl. 455/558

(57) ABSTRACT

A system and apparatus that allows cell phone users to control the roaming features of their service from one telecommunication network (i.e., cellular service provider) to another at the device level, independently of a particular primary network. More specifically, it intends to perform primary functions using the principles of (SoC) design, allowing an array of third party smart cards to share the motherboard of the universal cellular circuit, thus, allowing for ease of switching service providers by simply pushing a button on the apparatus. In addition, this device is equipped with a digital security diagnostic port (DSDP), allowing the scanning of the physical layer of the cellular circuit for unwanted/unexpected chips and other digital security breaches. For the cause of unprecedented efforts to accelerate the design, production, implementation, and distribution of new technologies (SoC design, ESL design, Robotics . . . ), this invention addresses a future threat to human-computer interactions (HCI) and public safety.

### CROSS-REFERENCE TO RELATED APPLICATION

The present application claims the benefit of previously filed co-pending Provisional Patent Application, Ser. No 60/658,035 filed Mar. 2, 2005,

### FIELD OF INVENTION

This invention relates, generally, to a system and apparatus for allowing cell phone users to control the roaming features of their service from one telecommunication network (i.e., service provider) to another at the device level, independently of a particular primary network. More specifically, it intends to perform primary functions using the principles of system on chips design (SoC), allowing an array of third party smart cards to share the mother cellular board for ease of switching service providers by simply pushing a button on the apparatus. In addition, this device is equipped with a digital security diagnostic port (DSDP), allowing the scanning of the physical layer of the cellular circuit for unwanted/unexpected chips and other digital security breaches.

### BACKGROUND OF THE INVENTION

As the growing portion of the population of cell phone users begin to experience frustration due to overcrowded information network infrastructure, there is a need for improved service parameters and increased control by the retail user. This is the beginning of a more serious problem, which will need to be addressed sooner than later. The number of cellular users continues to increase at an exponential rate while landlines are being discontinued at an alarming rate. This problem is not new and is getting more and more press. It is also very appropriate to note that a large number of cautious telecom engineers have been working diligently to avail more channels of communications to a demanding mobile telecommunication marketplace such as CDMA (code division multiplexing access), TDMA (time division multiple access), and GSM (global system for mobile communication). Others maintain the search to ease data transfer and device swapping using SIM (subscriber identity module), real-time network activation, and multiple universal interface ports (USB). We must also note the creative features and options (still and/or video cameras, broadcast radio, RFID readers, to name a few) that several phone manufacturers are embedding with this ubiquitous all-in-one device. Many telecom giants identify this multipurpose telecommunication gadget as “the device formerly known as the cell phone”. Such connotation illustrates how mutated this device has become within the last decade.

Also, considering the increased incidence of terrorist attacks as well as the ever present threat of network entropy (system downtime), there exists a need for an apparatus to facilitate the quick and independent switch from one service provider to another while allowing authorized personnel to perform random security diagnostics of the physical layer of a cell phone (computers alike). In fact, the disclosed apparatus provides a solution to an important cyber-security issue often blurred under the shadow of what we have identified as “soft-defenses”(antivirus, encryption, software-based firewalls). Taking a similar approach, we have identified the protection and security of the physical layers (hardware) of the world's information infrastructure as “hard-defense” or hard-wall. There is an urgent need for such hard-walls in many digital devices and this device is equipped with said hard-wall.

Although the telecommunication industry is crowded with new technologies, none of these technologies addresses the particular security issue covered by this proposed apparatus. It should also be noted that no other device has so systematically and effectively addressed the environmental problem of digital pollution and electronic solid waste. With an average of four cell phones per household (based on a typical family of four), it is never too early to address technology-related environmental degradation and toxic chemical waste. This is a very difficult issue for the cell phone and computer manufacturers to resolve. In this context, the proposed universal cellular circuit is a win for the user, a win for the provider, and a win for the environment.

Upon loss of signal due to unavailability of service at a particular location, cell phone users are often forwarded to another network (a different service provider) that can offer coverage in such area. This process is known as roaming. When roaming from one network to another, the user often pays an excessive premium to compensate for this type of coverage rescue performed by the secondary network. Ironically, roaming, as we know it today, still attaches the user to his/her primary service provider (which often charges the user for processing the rescue transaction, because of complex accounting issues often associated with financial exchanges between competitive business entities). This new apparatus will allow the end user to independently select, perform, and manage his/her rescue operation. In the same manner, the application of the proposed device will free the competitive parties from having to deal with complex (time-consuming) data exchanges and complicated financial transactions.

Numerous systems and apparatus have been invented to increase network bandwidth and capacity (the number of lines available to potential subscribers). Other inventions are issued and sought for encryption (password protection, and platform robustness) and tracking mechanisms (i.e., GPS). Some inventions even attempt to protect user data via SIMs and other types of data acquisition and safeguarding protocols (network backup files, profile safekeeping). Other prior art relevant to this technology is discussed below.

U.S. Pat. No. 6,181,935 by Gossman, et al. discloses a mobility extended telecommunications application and method of use which comprises an integrated wireless and wirelined network with central control and which has a programmed interface to translate between the different protocols of the wireless and the wirelined networks to allow for customized services to be furnished to said wireless network without the necessity of expensive switching and data handling devices. The application can be utilized between many networks, such as enterprise networks, and facilitates the utilization of the architecture of the wirelined network and the home location register of the wireless network for various applications on the wireless network. Whereas the Grossman invention facilitates the use of quick and cost effective service “switching”, the system does not enable the end user to choose the method and service provided for the rescue operation. Moreover, the invention does not address security diagnostic methods or controls.

U.S. Pat. No. 6,850,763 by Naqvi, et al. discloses a system and method of servicing mobile communications with a proxy switch. The invention provides a proxy switch, communication methods, and communication logic for use in a mobile network. A proxy switch is deployed between a base station subsystem and a mobile station center. The proxy switch receives signaling messages and either retransmits them, blocks them, converts them, or siphons them to an alternative network. Besides providing an ability to offload mobile traffic it provides a platform for new communication services. Naqvi does propose solutions to wireless traffic routing, and speaks to roaming, however it does not enable the end user to have control of the switching nor does this invention speak to diagnostic security tools.

U.S. Pat. No. 6,859,649 by Denenberg, et al. discloses a method for registering with a communication service. This method determines whether a given mobile communication device is eligible to register for a particular service. A first database tracks the equipment capabilities of various mobile devices. A second database tracks which regions, of a plurality of geographic regions, are eligible to receive the service. These databases are checked when the system receives a request to register for the service. The Denenberg invention also does not enable the end user to have control of the service switching nor does this invention speak to diagnostic security tools.

U.S. Pat. No. 6,826,762 by Shell, et al. discloses a Radio Interface Layer (RIL). The RIL comprises an API set which provides a level of abstraction between the radio on a cell phone and the software of the cell phone. The API set of RIL is roughly based on the GSM AT interface as defined in GSM specifications 07.05 and 07.07. The API set provides access to functionality contained within a cellular telephone, such as a GSM or CDMA compatible telephone. These APIs allow applications running on an operating system in the cellular telephone to issue commands without knowledge of the underlying radio structure of the cellular telephone and specific knowledge of the GSM-type commands. For example, these APIs allow the applications to access to phonebook entries, restrict access to data and functionality using passwords, access file and message storage, and perform many other functions. The RIL is divided into a hardware-independent proxy layer, called by various software components, and a driver layer that is hardware-specific. The Shell invention also does not enable the end user to have control of the service switching nor does this invention speak to diagnostic security tools.

U.S. Pat. No. 6,768,727 by Sourour, et al. discloses a method of forward link power control in a CDMA mobile communication system as adapted for diversity transmission. First and second diversity signals are transmitted from a base station to a mobile terminal. The mobile terminal derives first and second channel quality estimates associated with the first and second diversity signals respectively. The mobile terminal uses the channel quality estimates to derive first and second power control codes which it transmits to said base station. The base station adjusts the transmit power of first and second antennas associated with the base station based on the first and second power control codes, respectively. This is a base station control feature and does not enable the end user to have control of the service switching nor does this invention speak to diagnostic security tools.

U.S. Pat. No. 6,732,301 by Landry, et al. discloses a digital system providing a serial bus diagnostic port such as, for example, a universal serial bus (USB) diagnostic port. The USB diagnostic port can include a USB slave device operable to interface to a universal serial bus, a flash memory controller interface coupled to the USB slave device and operable to interface to a flash memory controller, and a test access port controller coupled to the USB slave device and operable to interface to a test access port. The diagnostic port can further include a system interface coupled to the USB slave device and operable to interface to an integrated controller independently of an operating system. Via the diagnostic port, a USB testing tool with testing software can access and debug internal logic of the digital system. As an alternative to a USB diagnostic port, the serial bus diagnostic port can be implemented in a variety of wired or wireless implementations such as, for example, an I.E.E.E. 1394 diagnostic port, an Ethernet diagnostic port, or a wireless Internet diagnostic port. Further, the serial bus diagnostic port can, for example, be used for software development, in-factory testing or in-field diagnostics of the digital system. Although the Landry patent discusses a method of device port security that focused on software, it does not (1) seek to test the physical layers of a digital circuit for unwanted chips or (2) address the additional feature of the user controlling the service provider in real time.

None of these apparatuses describes a universal cellular circuit to avail end users with multiple choices of cellular service providers. None of these devices allows for the above feature along with a security inspection the physical layers of the circuit via a security diagnostic port.

Therefore, there is a need for a universal cellular circuit that permits the concurrent use of competitive technologies on a single platform, allowing the switch-and-swap of provider identification modules (PIMs) in a fashion similar to the swap with subscriber identity modules (SIMs). There is an equal need for a portable apparatus that can test the physical composites of a digital circuit and submit reliable results speedily in time critical situations.

It is the object therefore of this invention to provide a universal cellular circuit that permits the concurrent use of competitive telecommunication technologies on a single platform.

It is another object of this invention to provide a universal cellular circuit allowing the switch-and-swap of cellular service provider modules by the user.

It is yet another object of this invention to provide a means to test digital circuits (cell phones and computers) via a digital security diagnostic port.

This and other objects of the invention will in part be obvious and will in part appear hereinafter. For instance, further embodiment will include the implementation of such diagnostic apparatus in the design of personal computers and other electronic appliances.

### BRIEF DESCRIPTION OF THE FIGURES

The invention will now be described, by way of example only, with reference to the accompanying figures in which:

FIG. 1 is an environmental representation of a cellular phone, Master Circuit Board, and the Cellular Service Provider Modules including the embodiment contained herein.

FIG. 2 is an expanded representation of the phone illustrating the Cellular Service Provider Module slots, Master Circuit Board and security system.

### ITEMS OF THE FIGURES

1. Digital Security Diagnostic Port

2. Proprietary Ports/Connector

3. Cellular Service Provider Slot (swapper)

4. Cellular Service Provider Switch

5. Diagram of DSDP circuit (Hard-wall) placed into Master Circuit board

6. Cellular Service Provider chip placed into Master Circuit board

7. Filter placed into Master Circuit Board

8. Cellular Service Provider Module

9. Master Circuit board

### SUMMARY OF THE INVENTION

This invention relates to a system and apparatus that allows cell phone users to control the roaming features of their service from one telecommunication network service provider to another at the device level, independently of a particular primary network. This invention primarily uses the principles of silicon on chip (SoC) design to enable an array of third party smart cards to share the (integrated) universal cellular circuit board. By incorporating (in parallel) the Cellular Service Provider chips from up to four (or more) potential carriers into the device, the retail customer may simply choose his or her preferred service in the event of loss of service from the user's primary service provider. This event, termed a rescue, is typically an action delegated from the user to the cellular service or network thereof. The object of this invention is to put the control of the service switch into the realm of the end user. These third party smart cards can be made readily available by those skilled in the art.

In addition to the system chips, the device is equipped with a digital security diagnostic port or DSDP. This port allows for a scan of the physical layer of the cellular circuit for unwanted or unexpected chips and other digital security breaches. This feature of the invention enables an improved system of security to the device. As the role of the cell phone changes to become more of a personal attaché, the need for security becomes more critical. Hard-wall security methods are superior to traditional ‘soft-walled’ systems and are facilitated via this device.

### DESCRIPTION OF THE PREFERRED EMBODIMENT

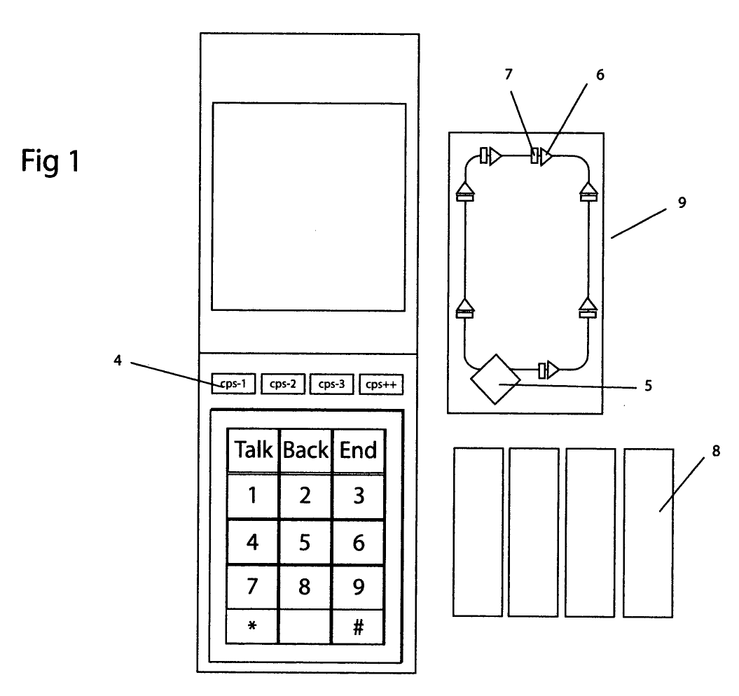

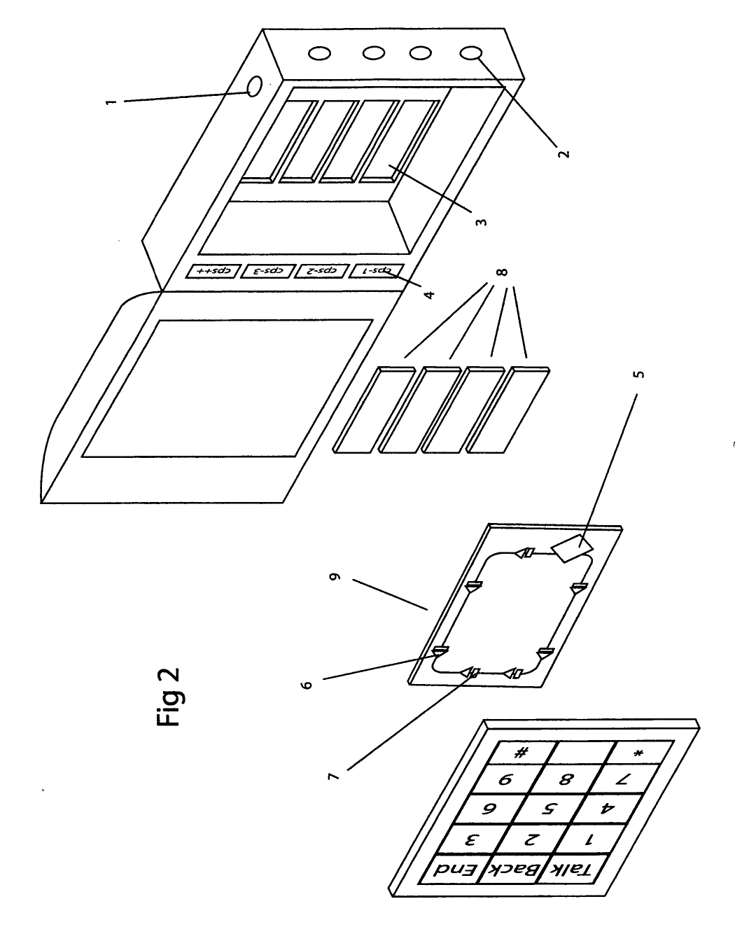

The present invention as shown in FIG. 1 is an apparatus comprised of a (1) Digital Security Diagnostic Port enabling a scan of the physical layer of the (9) Master Circuit board for unwanted or unexpected chips, or other digital security breaches, a number of (2) Proprietary Ports/Connectors, and a number of (4) Cellular Service Provider Switches. FIG. 2 shows an expanded view of the apparatus revealing a number of (3) Cellular Service Provider Slots (swappers), the (8) Cellular Service Provider Modules, and the (9) Master Circuit board. The plurality of (3) Cellular Service Provider Slots enable the end user to have a choice of various service providers that may be changed per the end user. The system on chips design for the (9) Master Circuit board allows for ease of dynamic service usage and “swapping” of (8) Cellular Service Provider Modules that are achievable by those skilled in the art.

The implementation of the feature of system on chips allows the end user to switch service providers by simply pressing the appropriate (4) Cellular Service Provider Switches due to, for example, an outage of specific service due to geographic constraints, service outage due to natural or terrorist event, or due to personal preference.

The use of the (7) filters with the (6) Cellular Service Provider chip placed into the (9) Master Circuit board within the device provides enhanced security to the device and the system. Access via the (1) Digital Security Diagnostic Port to the (9) Master Circuit board enables periodic scans of the device and enables hard wall security measures using scan methods well known in the art. The (1) Digital Security Diagnostic Port also enables the end user to determine whether security breaches have taken place and affords software and hardware upgrades to the device. This is critical due to the enhanced roll of the cell phone in today's market, for example for data storage, calendars, video, and audio.

As shown in FIG. 1 the system and device affords the flexibility of the addition of various other add-ons to the device using (2) Proprietary Ports/Connectors including potentially mass spectrometers, spectrophotometers, or other analytical tools.

Although this invention has been described in the form of a preferred embodiment, many modifications, additions, and deletions, may be made thereto without departure from the spirit and scope of the invention, a set forth in the following claims.

What is claimed is:

1. A mobile communication apparatus comprising:
a master circuit board capable of processing a plurality of cellular service signals;
a security diagnostic port in electrical communication with said master circuit board;
a plurality of cellular service provider slots in electrical communication with said master circuit board;
a plurality of cellular service provider switches in electrical communication with said master circuit board; and,
a plurality of cellular service provider modules removably in electrical communication with said master circuit board by insertion in said cellular provider slots.

2. The mobile communication apparatus of claim 1 wherein two or more of said cellular service provider modules are located within said cellular service provider slots.

3. The mobile communication apparatus of claim 3 wherein the end user is able to switch from one cellular service provider at the device level by selecting one of said plurality of cellular service provider switches.

4. The mobile communication apparatus of claim 1 wherein the end user is able to select one or a number of cellular service providers at the device level by acquiring desired cellular service provider's modules and inserting one of each said cellular service provider modules into one of each said cellular service provider slots.

5. The mobile communication apparatus of claim 1 further comprising a plurality of filters electrically connected between said cellular service provider slots and said master circuit board thereby enhancing security of the device.

6. The mobile communication apparatus of claim 1 wherein access via said digital security diagnostic port to said master circuit board enables periodic electrical scans of the physical device.

7. The mobile communication apparatus of claim 1 wherein a user can interact with said apparatus via said digital security diagnostic port to determine whether security breaches have taken place.

8. The mobile communication apparatus of claim 1 wherein a user can interact with said apparatus via said digital security diagnostic port thereby enabling software upgrades to the device.

9. The mobile communication apparatus of claim 1 wherein said apparatus further comprises a plurality of proprietary ports and connectors.

10. The apparatus of claim 10, wherein said proprietary ports and connectors facilitate other additions to the device.

11. The apparatus of claim 9, wherein said proprietary ports and connectors connect mass spectrometers to the device.

12. The apparatus of claim 9 wherein said proprietary ports and connectors connect spectrophotometers to the device.

13. The apparatus of claim 9 wherein said proprietary ports and connectors connect analytical tools to the device.

14. A mobile communication apparatus comprising:
A master circuit board capable of processing a plurality of cellular service signals;
A digital security diagnostic port in electrical communication with said master circuit board;
A plurality of cellular service provider switches in electrical communication with said master circuit board;
A number of cellular service provider slots in electrical communication with said master circuit board;
A number of proprietary ports and connectors in electrical communication with said master circuit board to facilitate other additions to the apparatus;
A plurality of filters electrically connected between said cellular service provider slots and said master circuit board thereby enhancing security of the device; and,
A plurality of cellular service provider modules removably in electrical communication with said master circuit board by insertion in said cellular provider slots.

15. The mobile communication apparatus of claim 14 wherein two or more of said cellular service provider modules are located within said cellular service provider slots.

16. The apparatus of claim 15, wherein said cellular service provider switches control access to said plurality of cellular service provider modules.

17. The mobile communication apparatus of claim 16 wherein the end user is able to switch from one cellular service provider to a different cellular service provider at the device level by selecting one of said plurality of cellular service provider switches.

18. The apparatus of claim 14, wherein said cellular service provider chip modules are easily interchangeable within the apparatus.

19. The apparatus of claim 14, wherein the apparatus may be accessed via the digital security diagnostic port for a security check scan of the physical layer of the apparatus.

20. The apparatus of claim 14, wherein said apparatus may be accessed via the digital security diagnostic port for loading software upgrades.
